(19) United States
(12) Patent Application Publication
(10) Pub. No.: US 2025/0178872 A1
(43) Pub. Date: Jun. 5, 2025

(54) A SYSTEM FOR AMRS THAT LEVERAGES PRIORS WHEN LOCALIZING AND MANIPULATING INDUSTRIAL INFRASTRUCTURE

(71) Applicant: Seegrid Corporation, Pittsburgh, PA (US)

(72) Inventors: Sean Kelly, Media, PA (US); Tom Panzarella, Haddonfield, NJ (US); John Spletzer, Nokomis, FL (US); Nicholas Alan Melchior, Pittsburgh, PA (US); William Robert Ganucheau, Jr., Lafayette, LA (US); Omri Kalinsky, Tuscon, AZ (US)

(21) Appl. No.: 18/852,369

(22) PCT Filed: Mar. 28, 2023
(86) PCT No.: PCT/US2023/016551

§ 371 Date: Sep. 27, 2024

Related U.S. Application Data
(60) Provisional application No. 63/324,201, filed on Mar. 28, 2022.

(51) Int. Cl. B66F 9/06; G05D 1/667; G05D 101/15; G05D 105/28

(52) U.S. Cl. CPC B66F 9/063; G05D 1/667; G05D 2101/15; G05D 2105/28

(57) ABSTRACT

A system for localization and manipulation of infrastructure includes: a mobile robotics platform; one or more sensors configured to collect sensor data; a processor configured to process the sensor data to identify and localize the infrastructure; and a feedback device configured to confirm the system has correctly identified and localized the infrastructure. The system includes a database of infrastructure descriptors and may spatially register those descriptors to the mobile platform's environment. The mobile robotics platform may employ those infrastructure descriptors as priors to improve sensing and actuation in the identification, localization, and manipulation of infrastructure.

### CROSS REFERENCE TO RELATED APPLICATIONS

The present application claims priority to U.S. Provisional Appl. No. 63/324,201 filed on Mar. 28, 2022, entitled A System For AMRs That Leverages Priors When Localizing Industrial Infrastructure; which is incorporated herein by reference in its entirety.

The present application may be related to U.S. Provisional Appl. No. 63/430,184 filed on Dec. 5, 2022, entitled Just in Time Destination Definition and Route Planning; U.S. Provisional Appl. No. 63/430,190 filed on Dec. 5, 2022, entitled Configuring a System that Handles Uncertainty with Human and Logic Collaboration in a Material Flow Automation Solution; U.S. Provisional Appl. No. 63/430,182 filed on Dec. 5, 2022, entitled Composable Patterns of Material Flow Logic for the Automation of Movement; U.S. Provisional Appl. No. 63/430,174 filed on Dec. 5, 2022, entitled Process Centric User Configurable Step Framework for Composing Material Flow Automation; U.S. Provisional Appl. No. 63/430,195 filed on Dec. 5, 2022, entitled Generation of “Plain Language” Descriptions Summary of Automation Logic; U.S. Provisional Appl. No. 63/430,171 filed on Dec. 5, 2022, entitled Hybrid Autonomous System Enabling and Tracking Human Integration into Automated Material Flow; U.S. Provisional Appl. No. 63/430,180 filed on Dec. 5, 2022, entitled A System for Process Flow Templating and Duplication of Tasks Within Material Flow Automation; U.S. Provisional Appl. No. 63/430,200 filed on Dec. 5, 2022, entitled A Method for Abstracting Integrations Between Industrial Controls and Autonomous Mobile Robots (AMRs); and U.S. Provisional Appl. No. 63/430,170 filed on Dec. 5, 2022, entitled Visualization of Physical Space Robot Queuing Areas as Non Work Locations for Robotic Operations, each of which is incorporated herein by reference in its entirety.

The present application may be related to U.S. Provisional Appl. No. 63/348,520 filed on Jun. 3, 2022, entitled System and Method for Generating Complex Runtime Path Networks from Incomplete Demonstration of Trained Activities; U.S. Provisional Appl. No. 63/410,355 filed on Sep. 27, 2022, entitled Dynamic, Deadlock-Free Hierarchical Spatial Mutexes Based on a Graph Network, U.S. Provisional Appl. No. 63/346,483 filed on May 27, 2022, entitled System and Method for Performing Interactions with Physical Objects Based on Fusion of Multiple Sensors; and U.S. Provisional Appl. No. 63/348,542 filed on Jun. 3, 2022, entitled Lane Grid Setup for Autonomous Mobile Robots (AMRs); U.S. Provisional Appl. No. 63/423,679, filed Nov. 8, 2022, entitled System and Method for Definition of a Zone of Dynamic Behavior with a Continuum of Possible Actions and Structural Locations within Same; U.S. Provisional Appl. No. 63/423,683, filed Nov. 8, 2022, entitled System and Method for Optimized Traffic Flow Through Intersections with Conditional Convoying Based on Path Network Analysis; U.S. Provisional Appl. No. 63/423,538, filed Nov. 8, 2022, entitled Method for Calibrating Planar Light-Curtain; each of which is incorporated herein by reference in its entirety.

The present application may be related to U.S. Provisional Appl. No. 63/324,182 filed on Mar. 28, 2022, entitled A Hybrid, Context-Aware Localization System For Ground Vehicles; U.S. Provisional Appl. No. 63/324,184 filed on Mar. 28, 2022, entitled Safety Field Switching Based On End Effector Conditions; U.S. Provisional Appl. No. 63/324,185 filed on Mar. 28, 2022, entitled Dense Data Registration From a Vehicle Mounted Sensor Via Existing Actuator; U.S. Provisional Appl. No. 63/324,187 filed on Mar. 28, 2022, entitled Extrinsic Calibration Of A Vehicle-Mounted Sensor Using Natural Vehicle Features; U.S. Provisional Appl. No. 63/324,188 filed on Mar. 28, 2022, entitled Continuous And Discrete Estimation Of Payload Engagement/Disengagement Sensing; U.S. Provisional Appl. No. 63/324,190 filed on Mar. 28, 2022, entitled Passively Actuated Sensor Deployment, U.S. Provisional Appl. No. 63/324,192 filed on Mar. 28, 2022, entitled Automated Identification Of Potential Obstructions In A Targeted Drop Zone; U.S. Provisional Appl. No. 63/324,193 filed on Mar. 28, 2022, entitled Localization Of Horizontal Infrastructure Using Point Clouds; U.S. Provisional Appl. No. 63/324,195 filed on Mar. 28, 2022, entitled Navigation Through Fusion of Multiple Localization Mechanisms and Fluid Transition Between Multiple Navigation Methods; U.S. Provisional Appl. No. 63/324,198 filed on Mar. 28, 2022, entitled Segmentation of Detected Objects Into Obstructions and Allowed Objects; and U.S. Provisional Appl. No. 62/324,199 filed on Mar. 28, 2022, entitled Validating The Pose Of An AMR That Allows It To Interact With An Object, each of which is incorporated herein by reference in its entirety.

The present application may be related to U.S. patent application Ser. No. 11/350,195, filed on Feb. 8, 2006, U.S. Pat. No. 7,446,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near-Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same; U.S. patent application Ser. No. 12/361,379, filed on Jan. 28, 2009, U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; U.S. patent application Ser. No. 29/398,127, filed on Jul. 26, 2011, U.S. Pat. No. D680,142, Issued on Apr. 16, 2013, entitled Multi-Camera Head; US Design patent application Ser. No. 29/471,328, filed on Oct. 30, 2013, U.S. Pat. No. D730,847, Issued on Jun. 2, 2015, entitled Vehicle Interface Module; U.S. patent application Ser. No. 14/196,147, filed on Mar. 4, 2014, U.S. Pat. No. 9,965,856, Issued on May 8, 2018, entitled Ranging Cameras Using A Common Substrate; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 16/892,549, filed on Jun. 4, 2020, US Publication Number 2020/0387154, Published on Dec. 10, 2020, entitled Dynamic Allocation And Coordination of Auto-Navigating Vehicles and Selectors; U.S. patent application Ser. No. 17/163,973, filed on Feb. 1, 2021, US Publication Number 2021/0237596, Published on Aug. 5, 2021, entitled Vehicle Auto-Charging System and Method, U.S. patent application Ser. No. 17/197,516, filed on Mar. 10, 2021, US Publication Number 2021/0284198, Published on Sep. 16, 2021, entitled Self-Driving Vehicle Path Adaptation System and Method; U.S. patent application Ser. No. 17/490,345, filed on Sep. 30, 2021, US Publication Number 2022-0100195, published on Mar. 31, 2022, entitled Vehicle Object-Engagement Scanning System And Method; U.S. patent application Ser. No. 17/478,338, filed on Sep. 17, 2021, US Publication Number 2022-0088980, published on Mar. 24, 2022, entitled Mechanically-Adaptable Hitch Guide each of which is incorporated herein by reference in its entirety.

### FIELD OF INTEREST

The present inventive concepts relate to the field of robotic vehicles and autonomous mobile robots (AMRs). In particular, the inventive concepts may be related to systems and methods in the field of detection and localization of infrastructure, which can be implemented by or in an AMR.

### BACKGROUND

Industrial AMRs need to sense the objects that they are manipulating or otherwise interfacing with. Broadly and collectively we refer to these objects as instances of “industrial infrastructure.” Concrete examples of such industrial infrastructure include, but are not limited to, pallets, racks, conveyors, tables, and tugger carts. Even when restricted to a particular class of an object (e.g., a pallet), large variations within that class can impact the success of the AMR's application.

### SUMMARY

In accordance with various aspects of the inventive concepts, provided is a system for localizing infrastructure, comprising: a mobile robotics platform; one or more sensors configured to collect sensor data; a processor configured to process the sensor data to identify and localize the infrastructure; and a feedback device configured to confirm the system has correctly identified and localized the infrastructure.

In various embodiments, the mobile robotics platform comprises an autonomous mobile robot.

In various embodiments, the one or more sensors comprises at least one 3D sensor.

In various embodiments, the at least one 3D sensor comprises at least one LiDAR scanner.

In various embodiments, the at least one sensor comprises at least one stereo camera.

In various embodiments, the one or more sensors includes one or more onboard vehicle sensors.

In various embodiments, the sensor data includes point cloud data.

In various embodiments, the system further comprises a localization system to estimate the pose of the mobile robotics platform.

In various embodiments, the system further comprises a non-volatile storage.

In various embodiments, the system is configured to identify and localize the infrastructure with the assistance of data from a database of infrastructure descriptors.

In accordance with various aspects of the inventive concepts, provided is a method for localizing infrastructure, comprising: providing a mobile robotics platform, comprising one or more sensors coupled to a processor and a memory device; providing a database of infrastructure descriptors; collecting sensor data using the one or more sensors; and identifying and localizing infrastructure using the sensor data and the database of infrastructure descriptors.

In various embodiments, the mobile robotics platform comprises an autonomous mobile robot.

In various embodiments, the one or more sensors comprises at least one 3D sensor.

In various embodiments, the at least one 3D sensor comprises at least one LiDAR scanner.

In various embodiments, the at least one sensor comprises at least one stereo camera.

In various embodiments, the one or more sensors includes one or more onboard vehicle sensors.

In various embodiments, the sensor data includes point cloud data.

In various embodiments, the method further comprises: revising the database of infrastructure descriptors based on the sensor data.

In various embodiments, the method further comprises: providing a localization system to estimate a pose of the mobile robotics platform; and the database of infrastructure descriptors comprises previously input data coupling an infrastructure descriptor and an associated pose of the mobile robotics platform.

### BRIEF DESCRIPTION OF THE DRAWINGS

The present inventive concepts will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is a perspective view of an AMR forklift that can be configured to implement dynamic path adjust, in accordance with aspects of the inventive concepts; and

FIG. 2 is a block diagram of an embodiment of an AMR, in accordance with aspects of the inventive concepts;

FIG. 3 through FIG. 5 illustrate various exteroceptive sensors that may be employed by an AMR in accordance with aspects of inventive concepts;

FIG. 6 and FIG. 7 illustrate various lift components such as may be employed by an AMR in accordance with aspects of inventive concepts;

FIG. 8 is a block diagram of semantic database in accordance with principles of inventive concepts;

FIG. 9 is a flow chart depicting training, dispatch and runtime activities of a robotic vehicle in accordance with principles of inventive concepts; and

FIGS. 10A through 10C illustrate a user interface such as may be employed during training.

### DETAILED DESCRIPTION OF PREFERRED EMBODIMENTS

Various aspects of the inventive concepts will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are being used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

In the context of the inventive concepts, and unless otherwise explicitly indicated, a “real-time” action is one that occurs while the AMR is in-service and performing normal operations. This is typically in immediate response to new sensor data or triggered by some other event. The output of an operation performed in real-time will take effect upon the system so as to minimize any latency.

Aspects of the inventive concepts disclosed herein relate to a system for constructing and using a database of human-curated priors for purposes of increasing the reliability of AMR sensing and manipulation of industrial infrastructure. In preferred embodiments, the system generalizes to any type of industrial infrastructure that may be spatially registered to a facility map. Use of a pre-constructed database of object classes discriminating the feature attributes among them can improve success rates. These data are exploited as priors for sensing and manipulation operations that cannot be easily determined at runtime.

Aspects of the inventive concepts defined herein leverage curation by a human operator to provide hints about the attributes (i.e., geometric or otherwise) of the infrastructure the AMR is tasked to localize or manipulate. These priors are collected into a database made available to the AMR at runtime.

In example embodiments robotic vehicle may include a user interface, such as a graphical user interface, which may also include audio or haptic input/output capability, that may allow feedback to be given to a human-trainer while registering a piece of industrial infrastructure (such as a pallet) to a particular location in the facility using a Graphical Operator Interface integral to the AMR. The interface may include a visual representation and associated text. In alternative embodiments, the feedback device may include a visual representation without text.

In example embodiments a system and method in accordance with principles of inventive concepts may, generally, entail three elements: 1) the collection of object parameters; 2) spatial registration of an object descriptor to a map associated with an action, manipulation or interaction; 3) the option of overriding trained descriptor values at the time of dispatch.

Collections of object parameters (i.e., descriptors) are given a globally unique name and an associated semantic meaning (for example, commonwealth handling equipment pool (CHEP) Pallet”). These descriptors are grouped into classes (e.g., “pallet types” and “infrastructure types”). As part of standard AMR route training procedures, a particular object descriptor is spatially registered to the AMR global map and associated with an action. The AMR global map is a stored map and the AMR may execute a route according to the global map. Using a concrete example, this registration can be thought of as a way to say: “At this location you can expect to pick and drop pallets of the type CHEP on infrastructure of type CONVEYOR.”

When an AMR is dispatched to perform an action with associated descriptors, new values may optionally be provided to “override” the trained values. For example, a different pallet type may be specified.

During training, a 1-to-N relationship between descriptors and facility locations may be modeled by the system for each applicable class. During dispatch, these descriptors may be replaced to use different parameters at the same spatially-registered location. At runtime, the data are queried by location which is estimated by the AMR's localization system. An M-to-N relationship may also be implemented. An M-to-N relationship allows multiple descriptors to be associated with any location so that each prior can be attempted (when using priors to improve perception performance) and/or a detection that matches any of the descriptor classes will be accepted (in the case of using descriptors of application correctness checking). The multiple descriptors may be assigned by the trainer during training, or there may be pre-built collections of multiple descriptors so that the trainer only needs to make one selection during training.

In accordance with one aspect of inventive concepts a system for providing priors to an AMR for purposes of identifying and localizing industrial infrastructure, includes a sensor for collecting data (e.g., imaging data from a LiDAR or 3D Camera); a computer for processing the sensor data; a software program that models the infrastructure; a means to parameterize the software model; a localization system to estimate the pose of the AMR; a feedback device for human confirmation of infrastructure localization during training; and non-volatile storage for persisting the trained data.

In accordance with another aspect of inventive concepts a method in accordance with principles of inventive concepts may include spatially registering descriptors that influence the localization of industrial infrastructure and using those priors at runtime. The method may include the steps of: prior to AMR operations, a human “walks” the AMR through the facility; at the time of walk-through, the AMR is equipped with a semantics database of facility infrastructure descriptors; during the walk-through, the human trainer stops at locations of interest and confirms via a feedback device that a particular descriptor is associated with a particular location; the location is estimated by the AMR localization system and this association between the AMR pose and the descriptor is serialized to a database queryable at runtime; when the AMR is dispatched to perform an action, descriptors may be overridden to provide new values to replace those specified during training; and at runtime, the AMR looks up the descriptor based on its estimated pose and parameterizes its behaviors from the data contained therein.

While the system described herein generalizes above any particular piece of facility infrastructure, in various embodiments, pallet handling tasks can leverage a pallet detection system, such as one available from IFM Electronics GMBH and the particular pallet descriptors employed are PDS-compatible. In example embodiments a software package such as Pallet Detection System may be employed to identify the 6-DoF pose of all standard 2-pocket pallets. The implicit goal of the PDS solution is to reduce the overall cycle time of pallet detection for autonomous and semi-autonomous pallet handling vehicles.

In some embodiments, the systems and methods described herein rely on the Grid Engine for spatial registration of the descriptors to the facility map. Some embodiments of the system may exploit features of the concurrently disclosed: “A Hybrid, Context-Aware Localization System for Ground Vehicles” which builds on top of the Grid Engine. Some embodiments leverage a Grid Engine localization system, such as that provided by Seegrid Corporation of Pittsburgh, PA described in U.S. Pat. Nos. 7,446,766 and 8,427,472, which are incorporated by reference in their entireties.

Aspects of inventive concepts described herein are advantageous and novel over prior approaches. The primary advantage of leveraging human-curated priors for purposes of AMR localization and manipulation is centered around system reliability. This is realized in two forms: 1) certain discriminating features of the object of interest may be imperceptible at runtime by the AMR sensors or would introduce intolerable computation times to detect; 2) human-curated priors act as validation gates for application correctness.

Aspects of inventive concepts described herein may be integrated into various embodiments. For example, aspects of inventive concepts herein may be introduced into any of a variety of types of AMRs, AMR lifts, pallet trucks and tow tractors, as examples. The system generalizes and could see value in future iterations of both the Pallet Truck and Tow Tractor lines.

In addition to employing a pre-existing database of known infrastructure descriptors, a user may create new descriptors for custom object types within a class of object that the system is aware of. For example, in an automotive manufacturing setting the system may maintain custom pallet-like containers and racks intended to move parts via a fork truck. If these custom objects are not already in the semantics database, so long as the object in question can be associated with a known object class, a custom descriptor could be developed that would allow perception and manipulation systems in accordance with principles of inventive concepts to interface with that device. In this example, the custom rack for carrying car parts with a fork truck could be added to the database with a custom pallet type descriptor and detected using the IFM PDS at runtime. Inventive concepts are not limited to the use of pallets and may be employed in any setting, within a facility or outside of one, where an AMR is to interact with, or manipulate, an object within its environment. The ability to override trained values at dispatch time allows the system to be tuned based on available information. For example, a warehouse management system may keep track of the types of pallets or loads at various locations in the facility and use this information to parameterize the routes sent to AMRs.

In some embodiments, an AMR may interface with industrial infrastructure to pick and drop pallets. In order for an AMR to accomplish this, its perception and manipulation systems in accordance with principles of inventive concepts may maintain a model for what a pallet is, as well as models for all the types of infrastructure for which it will place the pallet (e.g., tables, carts, racks, conveyors, etc.). These models are software components that are parameterized in a way to influence the algorithmic logic of the computation.

In an illustrative embodiment, a software component may be used to find tables that an AMR needs to place a pallet upon. For the sake of simplicity, a model of the table may be: 1) its surface is a plane; 2) it is rectangular; 3) the range of valid lengths are [x, y]; 4) The range of valid widths are [a, b]; 5) Its nominal surface-height is N meters off the ground. Based upon this, one can create a system in accordance with principles of inventive concepts representing a class of objects called “tables” and different types of tables can be parameterized by [x, y, a, b, N]. Each unique combination of these parameters defines a new type of table that the system is capable of detecting. In a given facility there may be, for example, three different table types to hold pallets, e.g., table types A, B, and C.

When the system is designed the expected table types may be mapped to locations in the facility where the action of dropping a pallet to a table will occur. To do this, an AMR-trainer or engineer may walk the AMR through the facility. During this walk-through, the position and orientation (pose) of the vehicle is being tracked by the AMR's localization system. Once the vehicle has reached the “action location” the trainer stops the AMR. Through a user-interface resident on the vehicle, a mapping from the current vehicle pose [x, y, 0] to the expected table type (e.g., A) is made and persistently recorded to a database.

When the AMR is dispatched, pick and drop actions are requested by a name, which is associated with the location during training. In example embodiments, the dispatch command may optionally contain a new descriptor to apply to the action, replacing the trained descriptor. This allows multiple collections of parameters to optionally be applied to the same spatial location. In practice, some classes of descriptors may frequently be overridden in this way, while others will remain static. For example, the infrastructure type (for example, table, rack, conveyor) at a given location is unlikely to change, but multiple types of pallets may be picked or dropped there.

At runtime, while the AMR is operating, its pose is being tracked by its localization system. Upon reaching the action location, for example, a “pallet drop action,” the AMR indexes into its semantic database by resolving its pose to an action location and the database returns A. This semantic hint is passed to the table localization software component to influence the processing. The net result is the AMR's ability to leverage a human-curated prior to increase the robustness of its perception and manipulation skills.

Inventive concepts may be applied to any scenario in which an AMR manipulates an object within its environment. Such concepts may be used in an application where the AMR employs a forklift mechanism, in a warehousing environment for example, to pick or place a payload. Inventive concepts may be employed in agricultural or forestry applications, as well. For example, in agriculture, exteroceptive information may be employed in an agricultural or forestry application to determine whether an object is a weed (do be picked) or a crop item (to be watered or fertilized). Similarly, in forestry such information may be employed by an AMR in accordance with principles of inventive concepts to determine navigation and manipulation strategies for pruning and picking branches or fruits. Inventive concepts may be employed in AMRs used in retail settings, such as store restockers and inventory counters; different products at different locations in a store may require different perception and manipulation strategies. Inventive concepts may be employed in maintenance and inspection robots; the navigation and inspection strategies depend on the location. For example, knowing the material or finish of a particular pipe or bridge component before inspection will help inform what a fault looks like. In agricultural applications, knowing what is planted in a particular location could help a weed-picking robot to determine which sprouts to pick, determining what plant to water and/or fertilize at particular locations, planning navigation and manipulation strategies for pruning and picking various fruits may employ inventive concepts. AMRs involved in maintenance and inspection may also employ inventive concepts in navigating and inspecting objects in the environment. Different forms of manipulators, including for example, forklift mechanisms, graspers, pincers, or others, may be employed in conjunction with an AMR in accordance with principles of inventive concepts. For brevity and clarity of explanation, inventive concepts will be described primarily in reference to an AMR operating within a warehouse environment and using a forklift mechanism to manipulate objects.

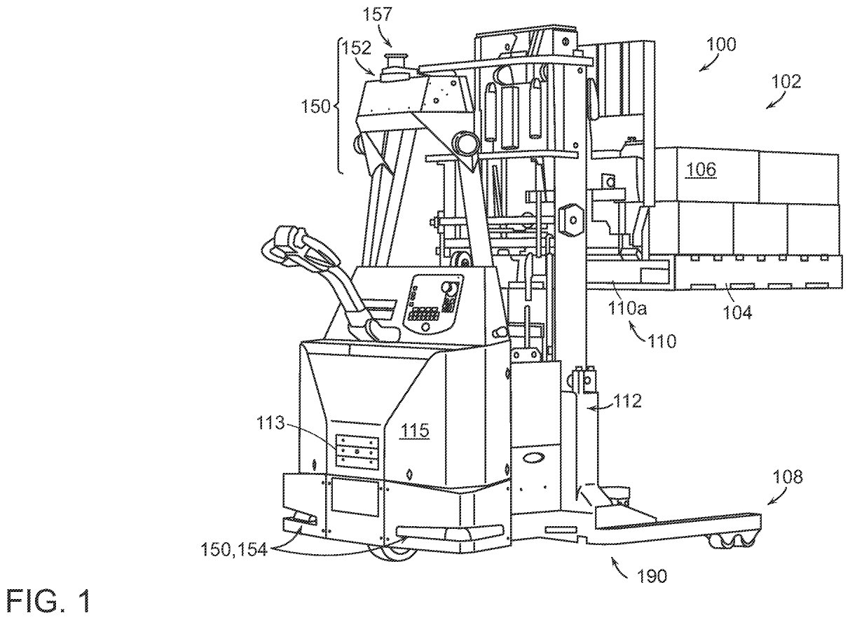

Referring to FIG. 1, shown is an example of a robotic vehicle 100 in the form of an AMR that can be configured with the sensing, processing, and memory devices and subsystems necessary and/or useful for performing dynamic path adjustment in accordance with aspects of the inventive concepts. The robotic vehicle 100 takes the form of an AMR pallet lift, but the inventive concepts could be embodied in any of a variety of other types of robotic vehicles and AMRs, including, but not limited to, pallet trucks, tuggers, and the like.

In this embodiment, the robotic vehicle 100 includes a payload area 102 configured to transport a pallet 104 loaded with goods 106. To engage and carry the pallet 104, the robotic vehicle may include a pair of forks 110, including a first and second fork 10a,b. Outriggers 108 extend from a chassis 190 of the robotic vehicle in the direction of the forks to stabilize the vehicle, particularly when carrying the palletized load 106. The robotic vehicle 100 can comprise a battery area 112 for holding one or more batteries. In various embodiments, the one or more batteries can be configured for charging via a charging interface 113. The robotic vehicle 100 can also include a main housing 115 within which various control elements and subsystems can be disposed, including those that enable the robotic vehicle to navigate from place to place.

The robotic vehicle 100 may include a plurality of sensors 150 that provide various forms of sensor data that enable the robotic vehicle to safely navigate throughout an environment, engage with objects to be transported, and avoid obstructions. In various embodiments, the sensor data from one or more of the sensors 150 can be used for path adaptation, including avoidance of detected objects, obstructions, hazards, humans, other robotic vehicles, and/or congestion during navigation. The sensors 150 can include one or more cameras, stereo cameras 152, radars, and/or laser imaging, detection, and ranging (LiDAR) scanners 154. One or more of the sensors 150 can form part of a 2D or 3D high-resolution imaging system. The sensors 150 can also include a LiDAR 157 for navigation and/or localization.

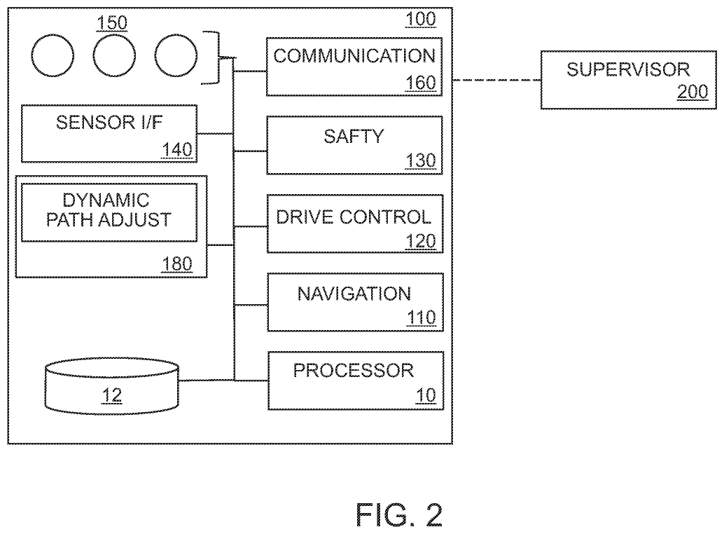

FIG. 2 is a block diagram of components of an embodiment of the robotic vehicle 100 of FIG. 1, incorporating path adaptation technology in accordance with principles of inventive concepts. The embodiment of FIG. 2 is an example; other embodiments of the robotic vehicle 100 can include other components and/or terminology. In the example embodiment shown in FIGS. 1 and 2, the robotic vehicle 100 is a warehouse robotic vehicle, which can interface and exchange information with one or more external systems, including a supervisor system, fleet management system, and/or warehouse management system (collectively “Supervisor 200”). In various embodiments, the supervisor 200 could be configured to perform, for example, fleet management and monitoring for a plurality of vehicles (e.g., AMRs) and, optionally, other assets within the environment. The supervisor 200 can be local or remote to the environment, or some combination thereof.

In various embodiments, the supervisor 200 can be configured to provide instructions and data to the robotic vehicle 100, and to monitor the navigation and activity of the robotic vehicle and, optionally, other robotic vehicles. The robotic vehicle can include a communication module 160 configured to enable communications with the supervisor 200 and/or any other external systems. The communication module 160 can include hardware, software, firmware, receivers and transmitters that enable communication with the supervisor 200 and any other external systems over any now known or hereafter developed communication technology, such as various types of wireless technology including, but not limited to, WiFi, Bluetooth, cellular, global positioning system (GPS), radio frequency (RF), and so on.

As an example, the supervisor 200 could wirelessly communicate a path for the robotic vehicle 100 to navigate for the vehicle to perform a task or series of tasks. The path can be relative to a map of the environment stored in memory and, optionally, updated from time-to-time, e.g., in real-time, from vehicle sensor data collected in real-time as the robotic vehicle 100 navigates and/or performs its tasks. The sensor data can include sensor data from sensors 150. As an example, in a warehouse setting the path could include a plurality of stops along a route for the picking and loading and/or the unloading of goods. The path can include a plurality of path segments. The navigation from one stop to another can comprise one or more path segments. The supervisor 200 can also monitor the robotic vehicle 100, such as to determine robotic vehicle's location within an environment, battery status and/or fuel level, and/or other operating, vehicle, performance, and/or load parameters.

In example embodiments, a path may be developed by “training” the robotic vehicle 100. That is, an operator may guide the robotic vehicle 100 through a path within the environment while the robotic vehicle, through a machine-learning process, learns and stores the path for use in task performance and builds and/or updates an electronic map of the environment as it navigates. The path may be stored for future use and may be updated, for example, to include more, less, or different locations, or to otherwise revise the path and/or path segments, as examples.

As is shown in FIG. 2, in example embodiments, the robotic vehicle 100 includes various functional elements, e.g., components and/or modules, which can be housed within the housing 115. Such functional elements can include at least one processor 10 coupled to at least one memory 12 to cooperatively operate the vehicle and execute its functions or tasks. The memory 12 can include computer program instructions, e.g., in the form of a computer program product, executable by the processor 10. The memory 12 can also store various types of data and information. Such data and information can include route data, path data, path segment data, pick data, location data, environmental data, and/or sensor data, as examples, as well as the electronic map of the environment.

In this embodiment, the processor 10 and memory 12 are shown onboard the robotic vehicle 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across the supervisor 200, other vehicles, and/or other systems external to the robotic vehicle 100.

The functional elements of the robotic vehicle 100 can further include a navigation module 110 configured to access environmental data, such as the electronic map, and path information stored in memory 12, as examples. The navigation module 110 can communicate instructions to a drive control subsystem 120 to cause the robotic vehicle 100 to navigate its path within the environment. During vehicle travel, the navigation module 110 may receive information from one or more sensors 150, via a sensor interface (I/F) 140, to control and adjust the navigation of the robotic vehicle. For example, the sensors 150 may provide sensor data to the navigation module 110 and/or the drive control subsystem 120 in response to sensed objects and/or conditions in the environment to control and/or alter the robotic vehicle's navigation. As examples, the sensors 150 can be configured to collect sensor data related to objects, obstructions, equipment, goods to be picked, hazards, completion of a task, and/or presence of humans and/or other robotic vehicles.

A safety module 130 can also make use of sensor data from one or more of the sensors 150, including LiDAR scanners 154, to interrupt and/or take over control of the drive control subsystem 120 in accordance with applicable safety standard and practices, such as those recommended or dictated by the United States Occupational Safety and Health Administration (OSHA) for certain safety ratings. For example, if safety sensors detect objects in the path as a safety hazard, such sensor data can be used to cause the drive control subsystem 120 to stop the vehicle to avoid the hazard.

The sensors 150 can include one or more stereo cameras 152 and/or other volumetric sensors, sonar sensors, and/or LiDAR scanners or sensors 154, as examples. Inventive concepts are not limited to particular types of sensors. In various embodiments, sensor data from one or more of the sensors 150, e.g., one or more stereo cameras 152 and/or LiDAR scanners 154, can be used to generate and/or update a 2-dimensional or 3-dimensional model or map of the environment, and sensor data from one or more of the sensors 150 can be used for the determining location of the robotic vehicle 100 within the environment relative to the electronic map of the environment.

Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

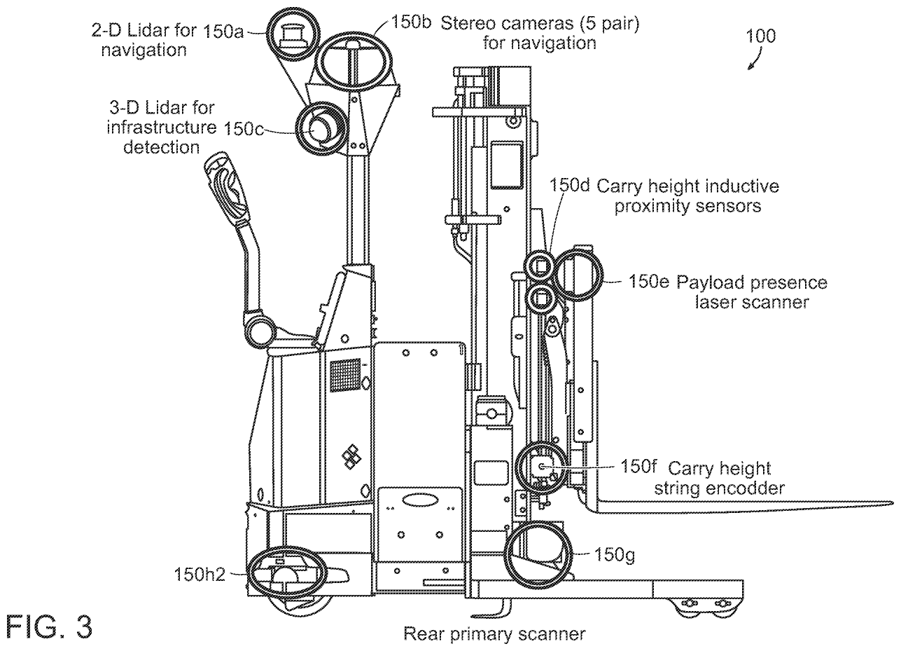

The robotic vehicle 100 (also referred to herein as AMR 100) of FIG. 3 provides a more detailed illustration of an example distribution of a sensor array such as may be employed by a lift truck embodiment of an AMR in accordance with principles of inventive concepts. In this example embodiment exteroceptive sensors include: a two-dimensional LiDAR 150a for navigation; stereo cameras 150b for navigation; three-dimensional LiDAR 150c for infrastructure detection; carry-height sensors 150d (inductive proximity sensors in example embodiments); payload/goods presence sensor 150e (laser scanner in example embodiments); carry height string encoder 150f; rear primary scanner 150g; and front primary scanner 150h.

Any sensor that can indicate presence/absence or measurement may be used to implement carry-height sensors 150d; in example embodiments they are attached to the mast and move with the lift, or inner mast. In example embodiments the sensors may be configured to indicate one of three positions: below carry height (both sensors on), at carry height (one on, one off), above carry height (both sensors off). Safety module 130 may employ those three states to control/change the primary safety fields. In example embodiments, when the forks are below carry height, the rear facing scanner may be ignored if the payload may be blocking the view of the scanner. When the forks are at carry height, and all other AMR factors are nominal (that is, reach is retracted, nominal speed, forks centered, et.,) standard safety fields may be for all scanners. When the lift is above carry height, the safety fields around the AMR may be expanded for added safety. The carry height string encoder 150f reports the height of the mast to safety module 130. Any of a variety of encoders or position sensing devices may be employed for this task in accordance with principles of inventive concepts. The carry height string encoder 150f may also be used in addition to or in place of the carry height inductive proximity sensors to adjust safety fields in accordance with principles of inventive concepts.

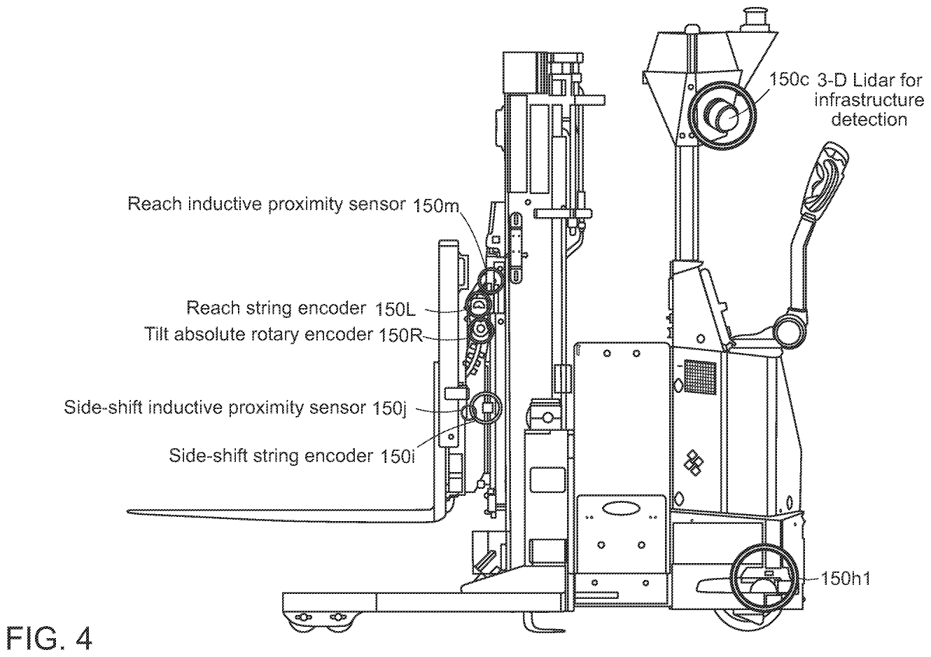

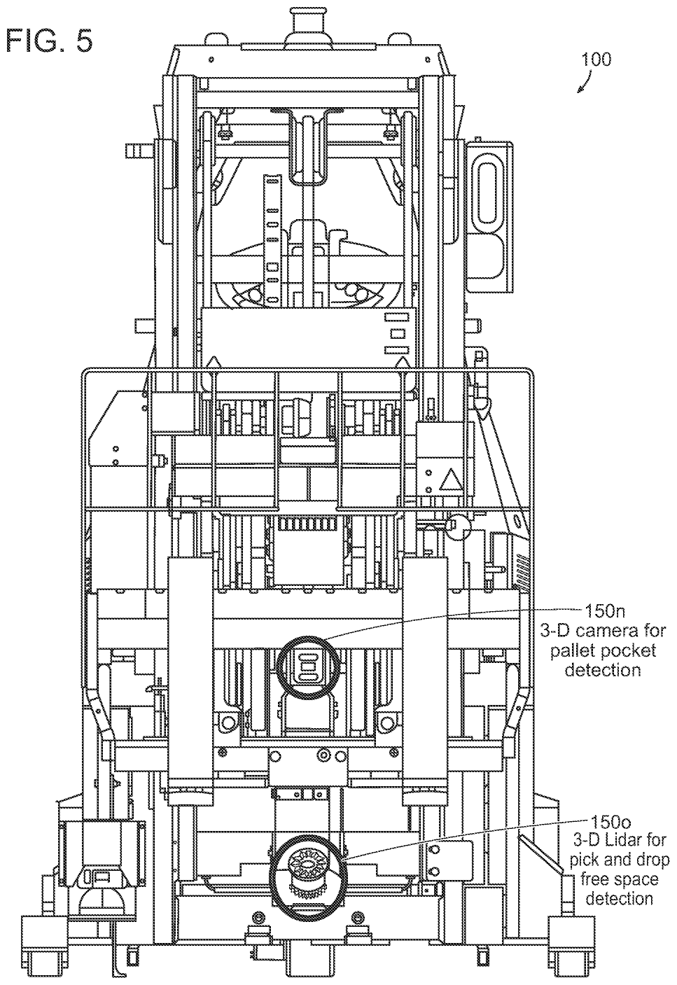

Additional scanners such may be employed by AMR 100 in accordance with principles of inventive concepts are shown in FIG. 4, where the sensors include: side shift string encoder 150i; side shift inductive proximity sensor 150j; tilt absolute rotary encoder 150k; reach string encoder 150i; and reach inductive proximity sensor 150m. Additionally, FIG. 5 illustrates an example embodiment of a robotic vehicle 100 that includes a three-dimensional camera 150n for pallet-pocket detection; and a three-dimensional LiDAR 1500 for pick and drop free-space detection.

Any of a variety of sensors that may indicate presence/absence may be used to determine reach and, in example embodiments, an AMR employs an inductive proximity sensor 150m. In example embodiments, this sensor indicates whether or not the pantograph is fully retracted. In example embodiments a metal flag moves with the pantograph and when the metal flag trips the sensor, the reach is considered to be fully retracted. If the pantograph is not fully retracted, the safety fields may be expanded to provide greater safety coverage, for example, the same coverage as though the pantograph is fully extended. When the pantograph is fully retracted safety module 130 may minimize the safety fields to improve the maneuverability of the AMR 100. Reach string encoder 150i may be employed to indicate the position of the pantograph and may be used in place of or in conjunction with the reach proximity sensor 150m.

Although a variety of sensors that indicate presence or absences may be employed, in example embodiments side shift may be indicated by the side-shift inductive proximity sensor 150j. In example embodiments this sensor indicates whether the pantograph is centered left-to-right when viewing the AMR from the rear. In example embodiments a metal flag shifts with the pantograph and when this flag trips the senor, the pantograph is considered centered. If the pantograph is not centered and a payload is present, safety module 130 may expand safety fields to accommodate the payload for any position of the side-shift of the pantograph. In this manner an AMR in accordance with principles of inventive concepts may increase the maneuverability of the AMR by minimizing the safety fields when the pantograph is centered. The side-shift encoder 150i indicates the side-shift position of the pantograph and may be used in place of, or in conjunction with, the side-shift inductive proximity sensor 150j to adjust safety fields.

In example embodiments an AMR may employ an inductive proximity sensor and encoder 150k to perform the tilt detection function of the pantograph. The tilt detection reports the pitch of the forks from front to back and may be employed by safety module 130 to adjust/control safety fields, for example. In example embodiments the sensors may provide binary results, such as presence or absence, which the safety module 130 may employ to establish a binary output, such as an expanded or compressed safety field. In example embodiments the sensors may provide graduated results, such as presence at a distance, which the safety module may employ to establish a graduated output, such as a variety of expansions or compressions of safety fields.

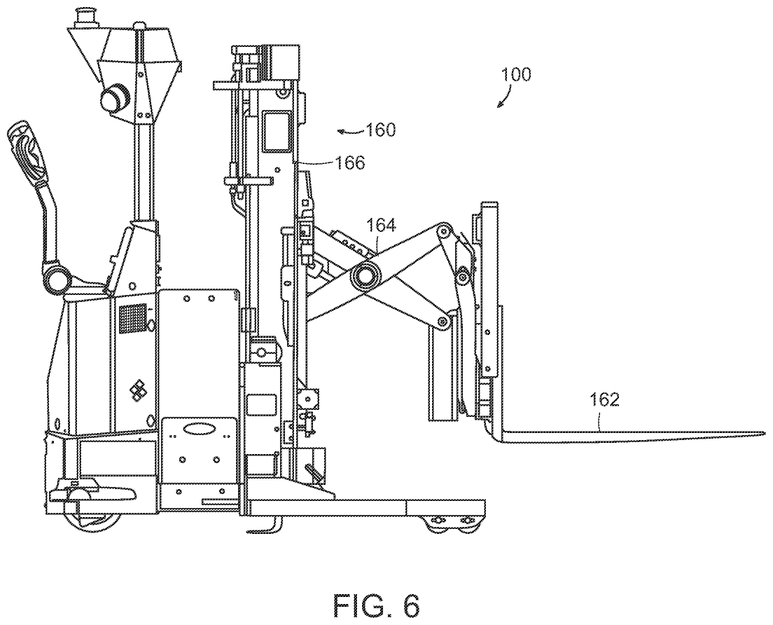

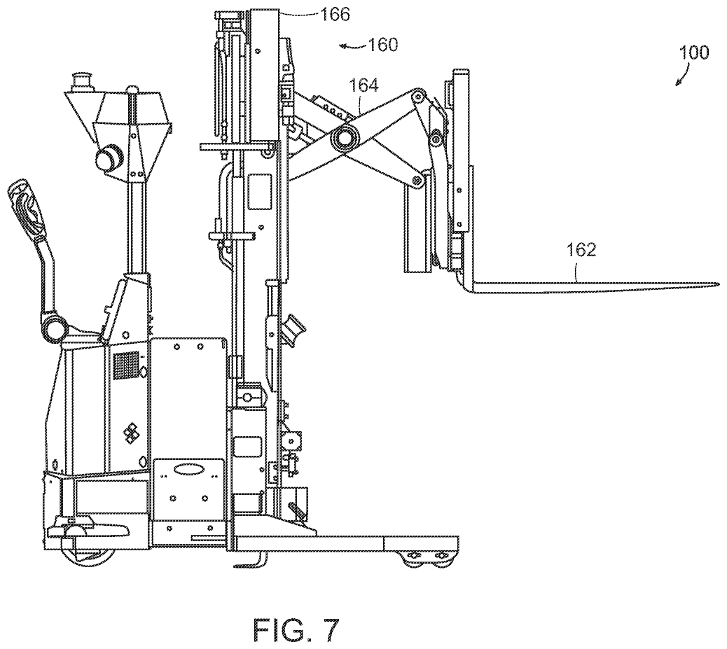

Turning now to FIG. 6, in example embodiments an AMR 100 may include components, which may be referred to herein collectively as mast 160, that includes forks 162, pantograph 164 and a vertical lifting assembly 166. Vertical lifting assembly 166 may include a lift cylinder, a tilt cylinder, a chain wheel, a chain, inner and outer masts, and a lift bracket, for example. Pantograph 164 may be extended or retracted to correspondingly extend or retract the “reach” of forks 162 away or toward the main body of the AMR. In the example of FIG. 6, lift assembly 166 has raised forks 162 to a travel height (a height suited for nominal vehicular travel within its given environment) and pantograph 164 has been extended to extend the reach of forks 162 away from the main body of robotic vehicle 100. A configuration such as this may be assumed by a vehicle 100 during the process of picking or placing a load, for example. FIG. 7 shows AMR 100 with forks 162 raised by lifting assembly 166 and extended by pantograph 164.

In example embodiments a system and method in accordance with principles of inventive concepts may train an AMR to carry out a manipulation operation, for example, within a facility within which the AMR is to interact with an infrastructure element. The infrastructure element may be fixed, quasi-fixed, or mobile, for example. One or more elements may be manipulated by the AMR and may be manipulated in relation to another element. For example, an AMR may be trained to pick (or place) a pallet from (to) a table, a rack, or conveyor. To train an AMR to pick up a pallet from a table an operator may place the AMR in training mode, interact with the AMR to identify the task it is about to learn, and then begin to walk the AMR through the facility. As the AMR is led through the facility, it employs its localization system to determine its location within the facility. An AMR in accordance with principles of inventive concepts may employ a localization system using grid mapping. The AMR may also employ simultaneous localization and mapping (SLAM). As the trainer walks the AMR through the facility to prescribed locations the trainer employs a user interface on the AMR to instruct the AMR to manipulate the environment in the manner it is to execute at that location.

In an example of a warehouse embodiment, an AMR may be led to a prescribed interaction site where a trainer walks the AMR, or trains the AMR, through the prescribed manipulation. The AMR uses its localization system to register the prescribed site within the warehouse. The trainer may, additionally, walk the AMR through the prescribed manipulation operation, using an AMR interface to indicate to the AMR what manipulations it is to be performed and with what infrastructure objects. For example, if the AMR is to pick a payload from a table at location X, the trainer may walk/lead the AMR to location X and step the AMR through a pick operation there. The trainer may employ a combination of training (for example, raising forks, extending forks, etc.) and interaction through a user interface (for example, entering the names of classified objects, such as “pallet”, or “table”) at the interaction site. The trainer may enter parameters or parameter ranges (lengths, widths, heights, shapes, for example) for the AMR to expect when actually executing the operation, after it is trained. When executing the operation the AMR may call up a parameterized object model to use in recognizing an object with which it is to interact. In example embodiments, the object's model and associated descriptor set may be used by the AMR's perception stack to allow the AMR to recognize the object and to interact with it. In example embodiments the object model (as defined by a set of parameters or descriptors) may be employed by the AMR as a prior probability distribution, also referred to as a “prior.” More precisely, the object model's parameters may be employed as an informative prior in a Bayesian probability process, allowing the AMR, through its perception stack, to recognize an object with which it is to interact. In example embodiments parameterized models of various objects with which an AMR may interact are stored in a semantic database. After training, the AMR is capable of repeating the operation for which it was trained, using its localization process to navigate the workplace and track where it is within that workspace and repeating its trained pose (the configuration and orientation of its manipulation mechanism, for example). In particular, the AMR keeps track of its localization and pose of its manipulation mechanism, which, in example embodiments may be a fork and mast combination. Elements of the forks' configuration may include: fork height, fork centering, tilt, and reach, for example. Descriptors, or parameters, of infrastructure objects may include: a range of widths, a range of heights, a range of opening heights, stringer, or block for pallet types; or planar surface, rectangularity, a range of valid lengths, a range of valid widths and nominal surface height for a table, for example.

Training information is retained by the AMR. After training the AMR may be dispatched, at which point the AMR is assigned a specific task such as: “pickup object A at location B and drop to location C.” The AMR's training allows the AMR to recognize the specific object (a Class A object) it is to pick and the specific objects, for example, a table at location B and conveyor at location C, with which it is to interact. At the time of dispatch, in accordance with principles of inventive concepts, an operator may substitute a model from a semantic database of models so that the AMR may then, at runtime, employ parameters of the substituted model in its recognition process for execution of its manipulation operation. The substituted model may be employed as a prior in a Bayesian model recognition process, allowing the AMR to manipulate an object during the course of its execution other than the object for which it had been trained.

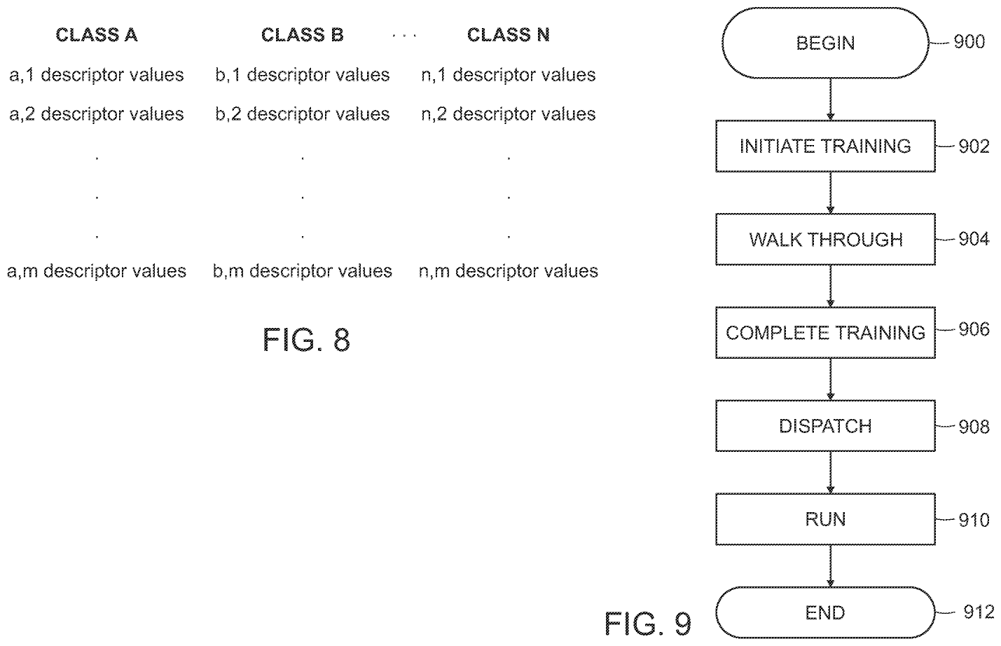

Turning now to FIG. 8, a system and method in accordance with principles of inventive concepts may employ a semantic database 800 of objects that an AMR may encounter in its working environment. Objects may be arranged in classes (class A through class N in the figure), with each class including objects (objects al through nm in the figure) defined by descriptor values. In a warehouse embodiment, for example, an AMR may encounter and interact with tables, racks, conveyors, belts, bins, rollers, and pallets, for example. Descriptor values for a pallet class of objects may include: a range of widths, a range of heights, a range of opening heights, stringer, or block for pallet types; or planar surface, rectangularity, a range of valid lengths, a range of valid widths and nominal surface height for a table, for example. The semantic database may be accessed by one or more AMRs operating within the work environment. The semantic database may be employed to provide descriptors, used as priors for a system in accordance with principles of inventive concepts' perception system to recognize objects. The semantic database may also, in accordance with principles of inventive concepts, provide the dimensions of specific objects, such as tables, within a facility, whether a certain table has rollers or is flat, or the types of pallets expected at a particular location.

Operation of an AMR in accordance with principles of inventive concepts may be illustrated with the flow chart of FIG. 9. The process begins in step 900 and proceeds from there to step 902 a training process is initiated. The training process is represented in steps 902 through 912 in this illustrative example. Training may entail a trainer interacting with the AMR through an interface, for example a graphical user interface that may include haptic and audio input/output capabilities, to set the AMR in a training mode. For purposes of illustration a warehouse environment will be used as an example of a training process in which an AMR manipulates an object within a workspace. As previously noted inventive concepts are not limited to such an environment and may encompass any environment or application within which an AMR may manipulate an object, including but not limited to warehousing, agriculture, forestry, retail, or restocking, for example.

After initiating the AMR's training mode the trainer positions the AMR at the starting point for the AMR's assigned task. Using its perception stack (including sensors described in the discussion related to prior figures and related software) the AMR localizes itself within the warehouse, registers, and stores this information. At one or more locations within the warehouse the AMR is trained to manipulate an object within its environment. For example, the AMR may pick up a palleted payload from a rack at location A travel to location B and place the palleted payload on a conveyor there. To effect this training a trainer walks the AMR to the locations and the AMR, which may employ a grid mapping system, learns the path to the manipulation location (step 904). At an interaction location the trainer employs an AMR user interface to indicate the type of interaction/manipulation the AMR is to carry out at the current location. The trainer may also indicate to the AMR the types of objects the AMR is to interact with, and the object's descriptor values. For example, the trainer may instruct the AMR to pick a payload using a pallet of a prescribed type (CHEP, block, stringer, for example) at this location and may orient the AMR's manipulation mechanism in the manner required to carry out the operation (pick, for example). For placing a payload, the trainer may enter a parameters of a table type, such as a range of heights, lengths, and widths and planarity of the table top, to assist the AMR in recognizing the particular infrastructure element and may orient the AMR for the operation, backing the forks in the direction of the table, for example. The AMR is positioned to scan the target object (pallet) and to store parameters from the scan in order to recognize the pallet when the operation is actually executed at runtime. Similarly, the AMR may then be led to location B where the AMR is similarly instructed on the type of infrastructure, for example a conveyor, upon which it is to place the payload. While walking the AMR through its planned operation the trainer may signal to the AMR in step 906 that the training is complete.

After training, in step 908 the AMR may be dispatched to carry out its previously learned assignment. At this time, in accordance with principles of inventive concepts, an operator may substitute a model from a semantic database for the object upon which the AMR was trained, allowing the AMR to, for example, manipulate a different type of pallet or place it on a different type of infrastructure object, for example. The process may proceed to running in step 910, with the new, substituted model, and end in step 912. Generally, training locations may be associated with real-world poses, using a grid map, by locating objects and manipulation sites at the position along a at which they are trained. A map for an entire facility could associate those locations with real-world locations at the time of training.

An AMR configured with a manipulator mechanism, such as a lift mechanism that may be used in warehousing or other applications, or a grasping mechanism that may be used in agricultural, forestry or restocking applications, performs a very complicated suite of sensing in order to adjust its movements and actuation to the particulars of a manipulation or interaction site. The manipulations occur by repositioning the AMR and four continuous axes of carriage motion based upon what the AMR perceives. The collection of possible pallets, tables, etc., is large and varied and the use of priors in accordance with principles of inventive concepts enables the perception system to employ the priors as “hints” to ensure that it detects the intended objects correctly. In example embodiments the associated object parameters may be quickly trained and registered to the particular training location.

Rather than requiring a trainer to walk the AMR through every detailed step of a manipulation operation (for example, inserting forks, lifting the forks, reversing, etc,) the system, though use of the semantic database and substituted priors, allows a trainer to avoid such detailed, tedious, operations during training. The semantic database may alter the sequence of operations at a specific location compared to other locations (for example, because the racking is shaped differently, or the load is unstable), but the trainer is spared the tedium. Additionally, the precise operation may change during execution at run time due to potential changes in the semantic information during dispatch (without retraining) and/or due to slight differences in a pallet's location, for example, which can be perceived by a system in accordance with principles of inventive concepts.

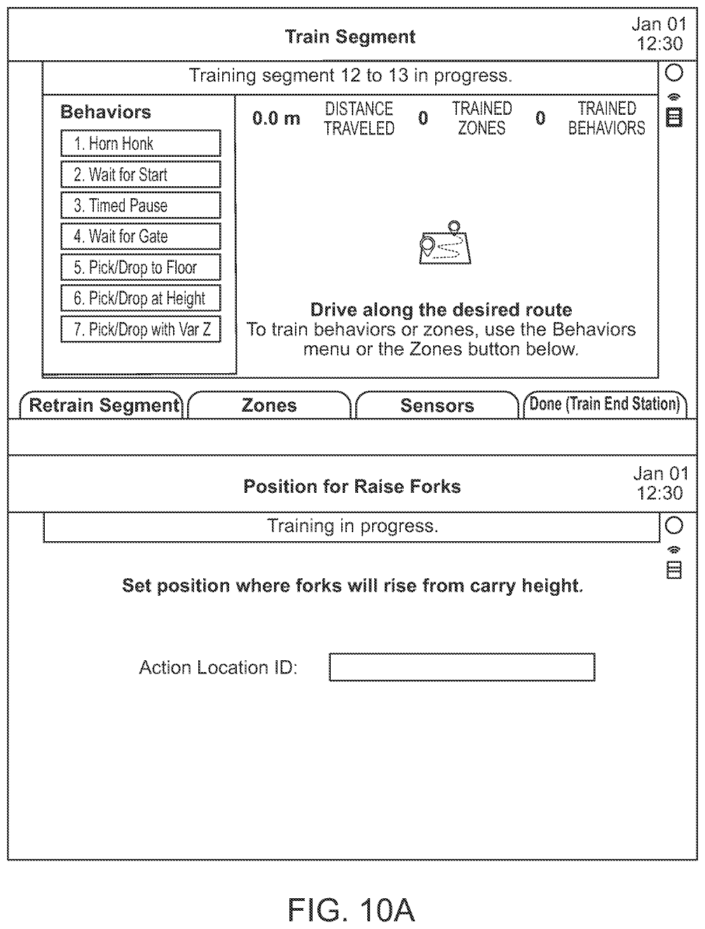

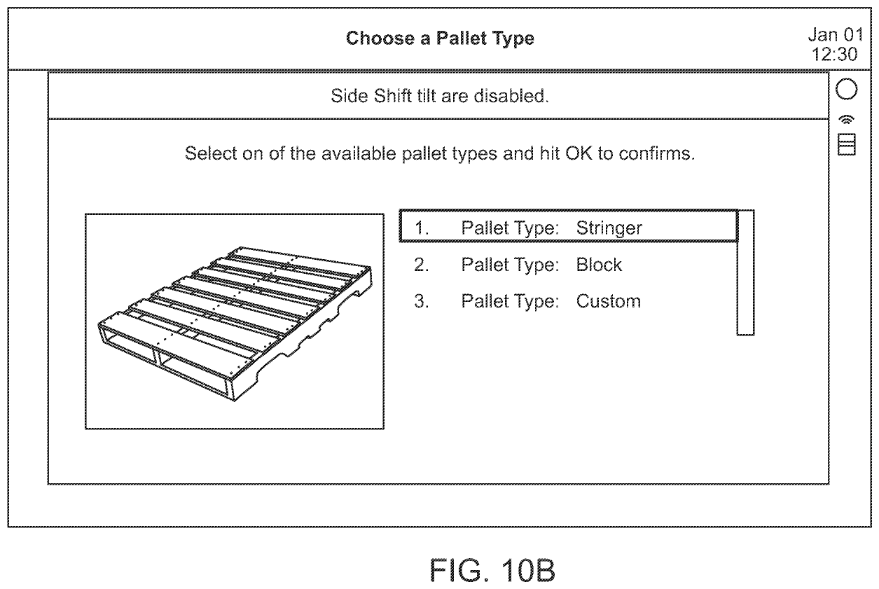

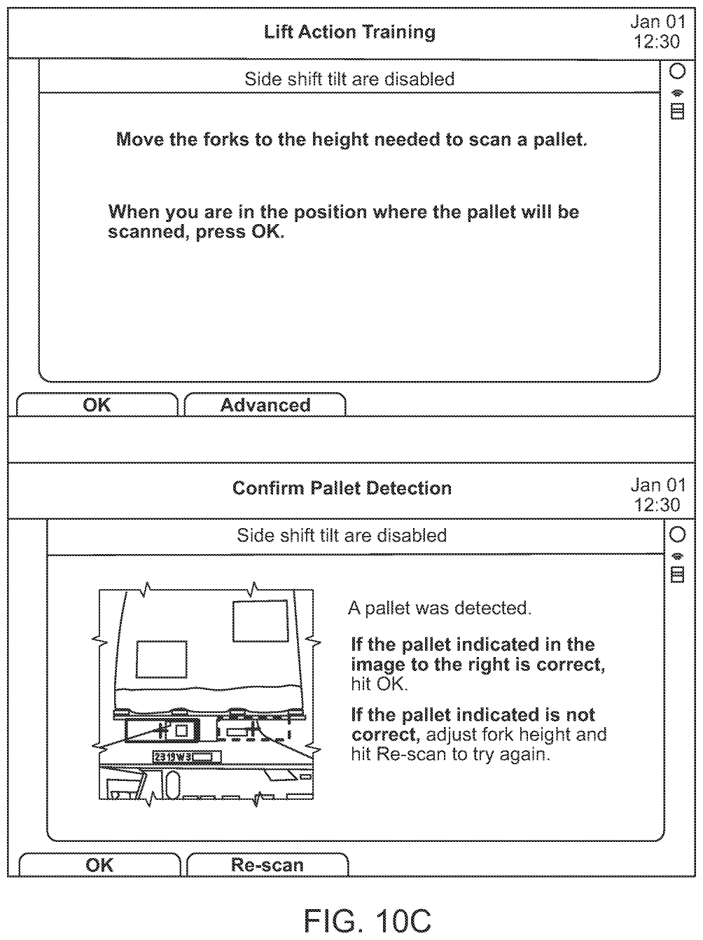

An AMR in accordance with principles of inventive concepts may employ a user interface such as that illustrated in FIGS. 10A through 10C. In FIG. 10 the interface provides the trainer with several options, such as the pick/drop height and whether to pick or drop from the floor. In order to register the location for the interaction the interface solicits an action identification location from the trainer. In FIG. 10B the trainer is given the option of pallet type that is to be used for this action/manipulation and in FIG. 10C the interface instructs the trainer to move the AMR's forks to the required height and interacts with the trainer in the process of pallet detection. If the pallet detection is successful, the trainer may adjust the fork height, for example, and attempt to rescan the pallet and, if successful, may proceed from their to similarly train additional actions.

While the foregoing has described what are considered to be the best mode and/or other preferred embodiments, it is understood that various modifications can be made therein and that aspects of the inventive concepts herein may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the inventive concepts, which are, for clarity, described in the context of separate embodiments, may also be provided in combination in a single embodiment. Conversely, various features of the inventive concepts which are, for brevity, described in the context of a single embodiment may also be provided separately or in any suitable sub-combination.

For example, it will be appreciated that all of the features set out in any of the claims (whether independent or dependent) can combine in any given way.

1-20. (canceled)

21. A system for localizing infrastructure, comprising:
a mobile robot configured for training within an environment;
one or more sensors configured to collect sensor data while the mobile robot navigates the environment; and
a processor configured to process the sensor data to identify object parameters, determine an infrastructure indicted by the object parameters, and spatially register the infrastructure to a location within the environment to localize the infrastructure during a training run.

22. The system of claim 21, wherein the processor is further configured to determine a pose of the mobile robot to localize the mobile robot.

23. The system of claim 21, wherein the system further comprises a semantic database including a plurality of object models,
wherein each object model embodies object parameters for a type of infrastructure, and the processor is further configured to access the object models to determine the infrastructure.

24. The system of claim 23, wherein the semantic database groups infrastructure object models into types of infrastructure object models based on the object parameters.

25. The system of claim 24, wherein the system is configured to be trained to manipulate infrastructure and to employ an infrastructure object model in that manipulation.

26. The system of claim 25, wherein the mobile robotics platform is configured to employ an infrastructure object model other than the one it was trained to employ in the manipulation.

27. The system of claim 23, wherein the system is configured to be trained to localize infrastructure and to employ an infrastructure object model in that localization.

28. The system of claim 23, further comprising:
a user interface responsive to operator inputs of attributes associated with infrastructure during training of the mobile robot,
wherein the processor is further configured to store the attributes as priors associated with the localized infrastructure for use during runtime.

29. The system of claim 28, wherein the attributes includes dimensional attributes of the infrastructure.

30. A method for localizing infrastructure, comprising:
providing a mobile robot;
training the mobile robot, including:
collecting sensor data while the mobile robot navigates an environment; and
processing the sensor data to identify object parameters, determine an infrastructure indicted by the object parameters, and spatially register the infrastructure to a location within the environment during a training run.

31. The method of claim 30, wherein the localization of the mobile robot includes determining a pose of the mobile robot.

32. The method of claim 30, further comprising providing a semantic database including a plurality of object models,
wherein each object model embodies object parameters for a type of infrastructure, and the method includes accessing the object models to determine the infrastructure.

33. The method of claim 32, further comprising the semantic database grouping infrastructure object models into types of infrastructure object models based on the object parameters.

34. The method of claim 33, wherein the system is trained to manipulate infrastructure and to employ an infrastructure object model in that manipulation.

35. The method of claim 34, further comprising employing an infrastructure object model other than the one it was trained to employ in the manipulation.

36. The method of claim 33, wherein the localizing the infrastructure includes training by employing an infrastructure model in that localization.

37. The method of claim 30, wherein the mobile robotics platform includes an autonomous mobile robot.

38. The method of claim 30, further comprising:
accepting operator inputs of attributes associated with the infrastructure via a user interface during training of the mobile robot,
including storing the attributes as priors associated with the localized infrastructure for use during runtime.

39. The method of claim 38, wherein the attributes includes dimensional attributes of the infrastructure.
